(19) United States
(12) Patent Application Publication
(10) Pub. No.: US 2019/0359872 A1
(43) Pub. Date: Nov. 28, 2019

(54) Heat-Dissipating Gel-Type Silicone Rubber Composition

(71) Applicant: KCC Corporation, Seoul (KR)

(72) Inventors: Il Hyuck Yoo, Suwon-si, Gyeonggi-do (KR); Jang Min Lee, Gunpo-si, Gyeonggi-do (KR); Tae Hwan Park, Seoul (KR)

(73) Assignee: KCC Corporation, Seoul (KR)

(21) Appl. No.: 16/486,601

(22) PCT Filed: Mar. 21, 2018
(86) PCT No.: PCT/KR2018/003250

§ 371 Date: Aug. 16, 2019

(30) Foreign Application Priority Data
Mar. 31, 2017 (KR) 10-2017-0041687

(51) Int. Cl. C09K 5/10; C08L 83/04; C08J 3/075

(52) U.S. Cl. CPC C09K 5/10; C08L 83/04; C08J 3/075; C08G 77/70; C08J 2383/04; C08J 2483/04; C08L 2205/025

(57) ABSTRACT

The present invention relates to a heat-dissipating gel-type silicone rubber composition including an organopolysiloxane, wherein the heat-dissipating gel-type silicone rubber composition further includes, with respect to 100 parts by weight of the organopolysiloxane, 0.1-25 parts by weight of an organo-hydrogen polysiloxane, 1,100-2,000 parts by weight of a filler, 5-50 parts by weight of a filler surface-treating agent, and 0.1-5 parts by weight of a catalyst, wherein the organopolysiloxane and the organo-hydrogen polysiloxane each include 1,000 ppm or less of a cyclic siloxane therein.

### TECHNICAL FIELD

The present invention relates to a heat-dissipating gel-type silicone rubber composition.

### BACKGROUND ART

In general, the heat-dissipating silicone rubber is used for dissipating heat from thermal conductive sheets used in electronic devices, and integrated circuit devices such as LSI (Large-Scale Integration) or CPU (Central Processing Unit), and serves to efficiently dissipate heat.

Conventionally, there was a thermally conductive silicone composition or the like which uses silicone oil as a main component and which further contains an inorganic filler such as magnesium oxide, aluminum oxide, aluminum nitride, boron nitride, silicon carbide, aluminum hydroxide, or zinc oxide powder. However, there was a problem in that the mechanical properties and thermal conductivity thereof are not sufficient due to the difficulty in effective dispersion of the filler. In addition, the workability in a work using a two-roll mill was not easy due to the presence of a large amount of the filler.

In addition, in order to solve the above problems, by forming an aluminum bridge through the effective surface treatment of the thermal conductive filler using a specific thermal conductive filler and a thermal conductivity enhancement surface treating agent, various silicone rubber compositions that can have easy workability, excellent mechanical properties and thermal conductivity were developed. However, there is still a problem to meet the satisfactory mechanical properties and heat resistance of a composition.

Therefore, there is a need to develop a silicone rubber composition to address the above-described problems of the related art, the silicone rubber composition having excellent thermal conductivity, and in particular, having improved heat resistance and thus capable of ensuring long-term reliability.

(Patent Document 1) U.S. application Ser. No. 08/654,493

(Patent Document 2) European Application No. 19960303759

### DISCLOSURE OF THE INVENTION

### Technical Problem

The present invention provides a heat-dissipating gel-type silicone rubber composition having improved heat resistance and thus capable of ensuring long-term reliability.

### Technical Solution

The present invention relates to a heat-dissipating gel-type silicone rubber composition including an organopolysiloxane, wherein the heat-dissipating gel-type silicone rubber composition further includes, with respect to 100 parts by weight of the organopolysiloxane, 0.1-25 parts by weight of an organo-hydrogen polysiloxane, 1,100-2,000 parts by weight of a filler, 5-50 parts by weight of a filler surface-treating agent, and 0.1-5 parts by weight of a catalyst, wherein the organopolysiloxane and the organo-hydrogen polysiloxane each include 1,000 ppm or less of a cyclic siloxane therein.

### Advantageous Effects

A heat-dissipating gel-type silicone rubber composition including an organopolysiloxane according to an embodiment of the present invention includes a cyclic siloxane in the content of no more than 1,000 ppm in the organopolysiloxane and the organo-hydrogen polysiloxane, thereby capable of reducing the amount of a low molecular siloxane which volatilizes from the composition during a curing process, can have not only excellent heat conductivity but also can improve heat resistance to ensure long-term reliability, and thus can be applied variously in the heat-dissipation market.

### MODE FOR CARRYING OUT THE INVENTION

Hereinafter, the present invention will be described in more detail with reference to the accompanying drawings.

Terms or words used in the specification and claims should not be interpreted as being limited to a conventional or dictionary meaning, and should be interpreted as the meaning and concept that accord with the technical spirit on the grounds of the principle that the inventor can appropriately define the concept of the term in order to explain invention in the best way.

A heat-dissipating gel-type silicone rubber composition including an organopolysiloxane according to an embodiment of the present invention includes, with respect to 100 parts by weight of the organopolysiloxane, 0.1-25 parts by weight of an organo-hydrogen polysiloxane, 1,100-2,000 parts by weight of a filler, 5-50 parts by weight of a filler surface-treating agent, and 0.1-5 parts by weight of a catalyst, wherein the organopolysiloxane and organo-hydrogen polysiloxane each includes 1,000 ppm or less of a cyclic siloxane therein.

The heat-dissipating gel-type silicone rubber composition according to an embodiment of the present invention includes a cyclic siloxane in the content of no more than 1,000 ppm in the organopolysiloxane and the organo-hydrogen polysiloxane, thereby capable of reducing the amount of a low molecular siloxane which volatilizes from the composition during a curing process, can have not only excellent heat conductivity but also can improve particularly heat resistance to ensure long-term reliability.

Hereinafter, each component contained in the heat-dissipating gel-type silicone rubber composition according to an embodiment of the present invention will be specifically described as follows.

Organopolysiloxane

An organopolysiloxane used according to an embodiment of the present invention is a silicone polymer which is included to form the backbone of the silicone gel after the silicone rubber composition has been cured, and may include two or more kinds of organopolysiloxanes, including a mixture of a first organopolysiloxane having the vinyl group at both ends or at both ends and side chains and a second organopolysiloxane having the vinyl group at one end or at one end and side chains.

According to an embodiment of the present invention, the first organopolysiloxane included in the organopolysiloxane is a polysiloxane having a vinyl group at both ends or both ends and side chains. A silicone-binding vinyl group in the first organopolysiloxane may be included in a range of 0.08-0.4 moles. When the silicone-binding group has the above range, the obtained composition may be cured sufficiently, and it is possible to prevent the physical property changes over time.

The first organic polysiloxane may include a silicone-binding organic group other than a silicone-binding vinyl group included at both ends or both ends and side chains. The organic group may be an alkyl group, such as methyl, ethyl, propyl, butyl, pentyl, hexyl, heptyl; an aryl group, such as phenyl, tolyl, xylyl, naphthyl; an aralkyl group, such as benzyl, phenethyl; and a alkyl halide group, such as chloromethyl, 3-chloropropyl, 3,3,3-trifluoropropyl. For example, the organic group may include a methyl group, a phenyl group, or both of these. The molecular structure of the first organopolysiloxane may be a straight-chain, a partially branched straight-chain, a branched chain, etc., for example, a straight-chain.

Examples of the first organopolysiloxane, which is included in the heat-dissipating gel-type silicone rubber composition according to an embodiment of the present invention may be, for example, a dimethyl polysiloxane end-blocked with a dimethyl vinyl siloxy group at both ends of the molecular chain; a methyl vinyl polysiloxane end-blocked with a dimethyl vinyl siloxy group at both ends of the molecular chain; a copolymer of a dimethyl siloxane and a methyl vinyl siloxane end-blocked with a dimethyl vinyl siloxy group at both ends of the molecular chain; a copolymer of a dimethyl siloxane, a methyl vinyl siloxane and a methyl phenylsiloxane end-blocked with a dimethyl vinyl siloxy group at both ends of the molecular chain; and a mixture of two or more of first organopolysiloxanes.

In addition, the viscosity of the first organopolysiloxane may be, at 25° C., in a range of 50 to 10,000 cP in the case of a polysiloxane having a vinyl group at both ends, or a range of 1,800 to 22,000 cP in the case of a polysiloxane having a vinyl group at both ends and side chains. Unless indicated otherwise, all viscosity measurements were performed by Brookfield LV DV-E viscometer at 25° C. When the viscosity at 25° C. is more than or equal to the lower limit of the range, the properties of the obtained silicon rubber are excellent, on the other hand, the resulting composition may represent better handling characteristics at lower than or equal to the upper limit of the described range.

The first organopolysiloxane may be included in the amount of 40-60 parts by weight with respect to the total 100 parts by weight of the organopolysiloxane.

Further, according to an embodiment of the present invention, the second organopolysiloxane included in the organopolysiloxane is a polysiloxane having a vinyl group at one end or at one end and side chains. A silicone-binding vinyl group in the second organopolysiloxane may be included in a range of 0.04-0.07 moles. When the silicone-binding vinyl group has the above range, the obtained composition may be cured sufficiently, and it is possible to prevent the physical property changes over time.

The second organic polysiloxane may include a silicone-binding organic group other than a silicone-binding vinyl group included at one end or at one end and side chains. The organic group may be an alkyl group, such as methyl, ethyl, propyl, butyl, pentyl, hexyl, heptyl; an aryl group, such as phenyl, tolyl, xylyl, naphthyl; an aralkyl group, such as benzyl, phenethyl; and a alkyl halide group, such as chloromethyl, 3-chloropropyl, 3,3,3-trifluoropropyl. For example, the organic group may include a methyl group, a phenyl group, or both of these. The molecular structure of the second organopolysiloxane may be a straight-chain, a partially branched straight-chain, a branched chain, etc., for example, a straight-chain.

The second organopolysiloxane, which is included in the heat-dissipating gel-type silicone rubber composition according to an embodiment of the present invention, is a polysiloxane in which the content of a low molecular siloxane is controlled, has a vinyl group at one end or at one end and side chains, and, for example, may use a compound represented by general formula 1.

(R¹_{c}R²_{3-c}SiO_{1/2})ₚ(SiO₂)_{q} [General formula 1]

In the general formula 1,

R¹ is a vinyl group,

R² is a homoatomic or heteroatomic hydrocarbon group having 1-20 carbon atoms,

c is an integer selected from 1-3, and

p and q each are an integer selected from 1-1,000.

(ViMe₂SiO_{1/2})₃₀ (SiO₂)₁₀ and (ViMe₂SiO_{1/2})₄₀ (SiO₂)₂₀ may be used as nonlimiting examples of the second organopolysiloxane. Here, Vi represents a vinyl group and Me represents a methyl group.

Further, the first organopolysiloxane and the second organopolysiloxane each are an organopolysiloxane in which a low molecular siloxane content is controlled (controlled volatile), and may include one or two or more of mixtures having a different viscosity or molecular weight. In addition, a cyclic siloxane having 3-10 siloxane units, for example, a cyclic siloxane having 5-10 siloxane units may be included in each of the first organopolysiloxane and the second organopolysiloxane.

The cyclic siloxane may be included in the amount of 1,000 ppm or less, for example, 100-800 ppm or less, 100-700 ppm or less, 100-600 ppm or less. When the content of the cyclic siloxane is 1,000 ppm or less, the low-boiling point fraction (low molecular siloxane) volatilized from the composition obtained during the curing process can be more significantly reduced, and it is possible to improve the heat resistance. If the content of the cyclic siloxane is more than 1,000 ppm, the content of the low molecular siloxane may be increased, and there may be a problem that the heat resistance becomes poor. Here, examples of the cyclic siloxane may be a cyclic dimethyl siloxane oligomer, a cyclic methyl vinyl siloxane oligomer, a cyclic methyl phenyl siloxane oligomer and a co-oligomer of a dimethyl siloxane and a methyl vinyl siloxane. The content of the cyclic siloxane having 3-10 siloxane units in the first organopolysiloxane and the second organopolysiloxane may be measured, for example, by analysis using gas chromatography.

The second organopolysiloxane may be included in the amount of 40-60 parts by weight with respect to the total 100 parts by weight of the organopolysiloxane. If the content of the second organo polysiloxane is less than 40 parts by weight, there may be a problem that the hardness, the heat resistance, etc. may be poor, and if the content of the second organopolysiloxane is more than 60 parts by weight, there may be a problem that the initial hardness of the silicone composition is lowered, and a tear or scratch after curing easily occurs.

According to an embodiment of the present invention, the weight ratio of the first organopolysiloxane and the second organopolysiloxane may be in a range of 40:60 to 60:40, and each of the first organopolysiloxane and the second organopolysiloxane may include one or two or more of mixtures so long as the weight ratio of the first organopolysiloxane and the second organopolysiloxane satisfies the above range. According to an embodiment of the present invention, the organopolysiloxane, which satisfies the mixing range, may have excellent physical properties such as viscosity, hardness, and heat resistance.

In addition, the viscosity of the second organopolysiloxane may be in a range of 900-1,100 cP at 25° C. When the viscosity at 25° C. satisfies the above range, the obtained silicone rubber has excellent physical properties and may exhibit excellent handling characteristics.

Organo-Hydrogen Polysiloxane

An organo-hydrogen polysiloxane contained in the heat-dissipating gel-type silicone rubber composition according to an embodiment of the present invention may be used as a hardening agent, and the organo-hydrogen polysiloxane may be included in the amount of 0.1-25 parts by weight with respect to 100 parts by weight of the organopolysiloxane.

According to an embodiment of the present invention, the mole ratio (H/Vi) of the silicone-binding hydrogen atom in the organo-hydrogen polysiloxane per 1 mole of the silicone-binding vinyl group in the organopolysiloxane may be 0.2 to 1.0, for example, 0.3 to 0.6. When the mole ratio has the above range, the obtained composition may be cured sufficiently, and it is possible to prevent the physical property changes over time.

According to an embodiment of the present invention, the organo-hydrogen polysiloxane may include a polysiloxane having a hydrogen atom at both ends or side chains, for example, the first organo-hydrogen polysiloxane and the second organo-hydrogen polysiloxane, the viscosity and structure of which are different from each other. The organopolysiloxane may include a mixture of the first organo-hydrogen polysiloxane having hydrogen atoms at side chains and the second organo-hydrogen polysiloxane having hydrogen atoms at both ends. At this time, all of the first organo-hydrogen polysiloxane and the second organo-hydrogen polysiloxane are the organo-hydrogen polysiloxane in which the content of the volatile powder is controlled.

The first organo-hydrogen polysiloxane included in the organopolysiloxane according to an embodiment of the present invention may use a compound represented by a general formula 2, the compound having hydrogen atoms at side chains.

R²₃SiO—(R²₂SiO)ᵣ(R²HSiO)ₛ—SiR²₃ [General formula 2]

In the general formula 2,

R² is a homoatomic or heteroatomic hydrocarbon group having 1-20 carbon atoms,

r is an integer of 0-1,000, and

s is an integer selected from 3-1,000.

The viscosity of the first organo-hydrogen polysiloxane may be in a range of 190-230 cP at 25° C. When the viscosity at 25° C. satisfies the above range, the obtained silicone rubber has excellent physical properties and may exhibit excellent handling characteristics.

In addition, the second organo-hydrogen polysiloxane included in the organopolysiloxane according to an embodiment of the present invention may use a compound represented by a general formula 3, the compound having hydrogen atoms at both ends of a molecule.

HR²₂SiO—(R²₂SiO)ₙ—SiR²₂H [General formula 3]

In the general formula 3,

R² is a homoatomic or heteroatomic hydrocarbon group having 1-20 carbon atoms, and

n is an integer selected from 3-1,000.

The viscosity of the second organo-hydrogen polysiloxane may be in a range of 100 to 1,020 cP at 25° C. When the viscosity at 25° C. satisfies the above range, the obtained silicone rubber has excellent physical properties and may exhibit excellent handling characteristics.

According to an embodiment of the present invention, as described above, two organo-hydrogen polysiloxanes, the viscosity and structure of which are different from each other, may co-exist in the composition. As a nonlimiting example, Me₃SiO (Me₂SiO)₈₅ (MeHSiO)₁₇SiMe₃, Me₃SiO (Me₂SiO)₂₀ (MeHSiO)₁₀SiMe₃, etc. may be used as the first organo-hydrogen polysiloxane, HMe₂SiO(Me₂SiO)₂₀SiMe₂H, HMe₂SiO (Me₂SiO) 50SiMe₂H, and HMe₂SiO (Me₂SiO)₂₂₀SiMe₂H may be used as the second organo-hydrogen polysiloxane, wherein Me represents a methyl group.

Further, the first organo-hydrogen polysiloxane and the second organo-hydrogen polysiloxane each are an organo-hydrogen polysiloxane in which a low molecular siloxane content is controlled (controlled volatile), and each of the first organo-hydrogen polysiloxane and the second organo-hydrogen polysiloxane may include one or two or more of mixtures having different viscosity or molecular weights from each other. In addition, a cyclic siloxane having 3-10 siloxane units, for example, a cyclic siloxane having 5-10 siloxane units may be included in each of the first organo-hydrogen polysiloxane and second organo-hydrogen polysiloxane. The cyclic siloxane may be included in the amount of 1,000 ppm or less, for example, 100-800 ppm or less, 100-700 ppm or less, 100-600 ppm or less. When the content of the cyclic siloxane is 1,000 ppm or less, the low-boiling point fraction volatilized from the composition obtained during the curing process can be more significantly reduced, and it is possible to achieve excellent hardness heat resistance. If the content of the cyclic siloxane exceeds 1,000 ppm, the hardness heat resistance may be poor and the low-boiling point fraction may be increased. Here, examples of the cyclic siloxane may be a cyclic dimethyl siloxane oligomer, a cyclic methyl vinyl siloxane oligomer, a cyclic methyl phenyl siloxane oligomer and a co-oligomer of a dimethyl siloxane and a methyl vinyl siloxane.

According to an embodiment of the present invention, the first organo-hydrogen polysiloxane may be included in the amount of 0.05-5 parts by weight, for example, the amount of 0.5-3 parts by weight with respect to 100 parts by weight of the organo polysiloxane. If the content of the first organo-hydrogen polysiloxane is less than the above range, the silicon rubber composition may not be cured, and if the content of the first organo-hydrogen polysiloxane exceeds the above range, too excessive curing density is obtained, and thus mechanical properties may be decreased.

In addition, according to an embodiment of the present invention, the second organo-hydrogen polysiloxane may be included in the amount of 0.05-20 parts by weight, for example, the amount of 1-10 parts by weight with respect to 100 parts by weight of the organo polysiloxane. If the content of the second organo-hydrogen polysiloxane is less than the above range, there may be a problem that too excessive curing density is formed, and thus mechanical properties may be decreased.

In the heat-dissipating gel-type silicone rubber composition according to an embodiment of the present invention, the weight ratio of the organopolysiloxane and organo-hydrogen polysiloxane may be 1:0.01 to 0.2, specifically 1:0.03 to 0.1. If the content of the organo-hydrogen polysiloxane with respect to the organo polysiloxane exceeds the above range, the physical properties of the obtained silicone rubber may be reduced, and if the content is less than above range, the curing may not occur sufficiently.

Filler

A filler contained in the heat-dissipating gel-type silicone rubber composition according to an embodiment of the present invention may include magnesium oxide, aluminum oxide (alumina), aluminum nitride, boron nitride, silicon carbide, aluminum hydroxide or two or more mixtures thereof as a thermal conductivity enhancement filling material. For example, the filler may include aluminum oxide, aluminum hydroxide or magnesium oxide, and another example may include aluminum oxide.

The crystal form of the filler may be a spherical or rectangular form, for example, a spherical form having an average particle size of 1-60 μm. In another example, the filler may be used by mixing a spherical aluminum oxide having an average particle diameter of 1-10 μm and a spherical aluminum oxide having an average particle diameter of 40-60 μm, and in this case, it is possible to have excellent mechanical properties and thermal conductivity by effectively loading the filler. The average particle diameter, for example, may be obtained as a cumulative average diameter of the volume reference by Horsfield's Packing Model.

When using a mixture of these two types of fillers, there is no particular limit to the mixing ratio, but the mixing ratio of the filler having an average particle diameter of 40-60 μm and the filler having an average particle diameter of 1-10 μm may be 1:0.1 to 1. If the mixing ratio of the filler having an average particle diameter of 40-60 μm and the filler having an average particle diameter of 1-10 μm exceeds the above range, an effective thermal conductivity may not be exhibited, and problems may occur in loading the filler.

According to an embodiment of the present invention, the content of the filler may be 1,100-2,000 parts by weight, for example, 1,300-1,600 parts by weight with respect to 100 parts by weight of the organopolysiloxane.

With respect to 100 parts by weight of the organopolysiloxane, if the content of the filler is less than 1,100 parts by weight, thermal conductivity may be significantly reduced, and if the content is more than 2,000 parts by weight, fluidity may be substantially decreased.

Filler Surface Treating Agent

A surface treating agent included in the heat-dissipating gel-type silicone rubber composition according to an embodiment of the present invention may include a methyl group, a dimethyl group, a trimethyl group, a methoxy group, or dimethoxy group at both ends or one end of the molecular chain as a filler surface treating agent. One or more selected from the group consisting of Me₃SiO, (Me₂SiO)₃₀ and SiMe(OMe)₂ (wherein Me represents a methyl group) may be included.

The filler may be included in the amount of 5-50 parts by weight, for example, 5-10 parts by weight with respect to 100 parts by weight of the organopolysiloxane. If the content of the filler surface treating agent is less than 5 parts by weight, dispersibility may be reduced, and if the content is more than 50 parts by weight, the heat resistance performance may be reduced.

The viscosity of the filler surface treating agent is in a range of 25-35 cP at 25° C., and the content of the volatile powder may be 0.35-0.65%.

Catalyst

A catalyst included in the heat-dissipating gel-type silicone rubber composition of the present invention may include a platinum-organic metal complex as a cross-linking accelerator to promote curing, for example, one or more selected from the group consisting of hexachloroplatinate, alcohol denatured hexachloroplatinate, coordination compound of hexachloroplatinate and olefin, vinyl siloxane or acetylene compounds, tetrakis (triphenylphosphine)palladium, chlorotris(triphenylphosphine)rhodium, 1,3-divinyl-1,1,3,3-tetramethyl-disiloxane-platinum(0)-composite, and H2PtCl6(Speier catalyst). The catalyst may be used in the amount of 0.1-5 parts by weight with respect to 100 parts by weight of the organopolysiloxane. When the content of the catalyst is less than 0.1 parts by weight, the cross-linking reaction may be slow and thus the curing may not be completed, and when the content of the catalyst is more than 5 parts by weight, the curing rate may be too fast, and thus the workability may not be good, and using a lot of expensive platinum is not economical.

Retarder

The heat-dissipating gel-type silicone rubber composition according to an embodiment of the present invention may include a retarder, and the retarder may serve to slow down the curing rate at room temperature. The retarder is typically not essential for the function of the coating itself, but the retarder may retard that a catalyst initiates or catalyzes the curing of the silicone composition at a relatively low temperature, such as room temperature.

A retarder available in accordance with an embodiment of the present invention is a specific material that can be used to retard the catalytic activity of a platinum metal-containing catalyst, and one or more compounds selected from the group consisting of methyl vinyl cyclic ([MeViSiO]ₙ, wherein n is an integer of 3-100), ethynylcyclohexanol, phenylbutanol, and surfynol may be used as the retarder. The curing retarder may be used in the amount of 0.001-1 parts by weight. When less than 0.001 parts by weight of the retarder is used, the curing rate may be too fast, and thus the workability may not be good, and when more than 1 part by weight of the retarder, the curing rate may be slow, and thus the curing may not be completed.

Other Additives

In addition, a colorant may be added to the composition of the present invention, for example, the colorant may include an inorganic pigment, e.g., titanium dioxide, ultramarine blue, iron oxide and carbon black, and an organic pigment, e.g., phthalocyanine, quinacridone, perilene and the like.

In addition, within the range that does not damage the purpose of the present invention, additives commonly available as any components, for example, pigments, antioxidants, wetting agent, defoamers, or flame retardants, etc. may further be included.

The heat-dissipating gel-type silicone rubber composition according to an embodiment of the present invention may be prepared by mixing the described-above components using a mixer, such as a dough mixer (kneader), a gate mixer, a streamlined mixer, a planetary mixer. Thus, the composition obtained in this way has a good workability, durability, reliability and improvement of significant thermal conductivity and heat resistance.

The heat-dissipating gel-type silicone rubber composition of the present invention, for example, may have a specific gravity of 2.9-3.1 determined according to ASTM D792 and a viscosity of 90,000-250,000 cP at 25° C. determined according to ASTM D4287. When the viscosity is within the above range, since the obtained composition easily has a good fluidity, the workability, such as dispense and screen print is easily improved, and applying the composition thinly to the substrate may be easy. Further, the thermal conductivity, for example, may be 3 W/mK or more determined according to JIS R 2616. In addition, even though about 3,000 cycle or more is performed at −40 to 175° C., the composition may maintain long-term stability without thermal shock.

The heat-dissipating gel-type silicone rubber composition having the above physical properties according to an embodiment of the present invention can significantly reduce, to about 200 ppm or less, the amount of a low molecular siloxane which volatilizes from the composition during the curing process, and have a good thermal conductivity. In particular, the composition as a heat-dissipating gel in which heat resistance is improved may ensure long-term reliability based on the heat resistance stability in the heat-dissipating market, such as automobile and LED light, and thus various application and proliferation of application may be possible.

Hereinafter, the present invention will be described in more detail according to the following embodiments, but the present invention is not limited thereto.

### EXAMPLES AND COMPARATIVE EXAMPLES

A heat-dissipating gel-type silicone rubber composition was prepared by the following method using components and contents represented below.

A first organopolysiloxane and a second organopolysiloxane each including a cyclic siloxane having 3-10 siloxane units in which the content of a volatile component was controlled were added to a container, and stirred at 70/300 RPM under atmospheric pressure of 1,013 mbar. Then, a filler and additives were added, followed by maintaining stirring under atmospheric pressure for 30 minutes, and then the mixture was scrapped. The mixture was then stirred at a reduced pressure for 2 hours while heated to 120° C. at 70/300 RPM under a pressure of 0-50 mbar. The mixture was then loaded to the reactor. The reaction mixture was stirred for about 20 minutes at 50/70 RPM under atmospheric pressure, 1,013 mbar, and then a non-dispersed compound was mainly scrapped. Next, a first organo-hydrogen polysiloxane and a second organo-hydrogen polysiloxane each including a cyclic siloxane having 3-10 siloxane units in which the content of a volatile component was controlled, a retarder and a catalyst were loaded to the reactor, and then were stirred for about 5 minutes at 50/70 RPM under atmospheric pressure of 1,013 mbar, and then were stirred at a reduced pressure for about 10 minutes at 60/150 RPM at a pressure of 0-50 mbar, thereby obtaining a heat-dissipating gel-type silicone rubber composition.

The component and content in each of examples and comparative examples are shown in tables 1-5 below.

<First Organopolysiloxane>

Organopolysiloxane-1 (a polysiloxane having a vinyl group at both ends, a viscosity of 2,000 cP at 25° C., a vinyl group content of 0.088 mole, a cyclic siloxane content of 400 ppm)

Organopolysiloxane-2 (a polysiloxane having a vinyl group at both ends, a viscosity of 450 cP at 25° C., a vinyl group content of 0.16 mole, a cyclic siloxane content of 350 ppm)

Organopolysiloxane-3 (a polysiloxane having a vinyl group at both ends, a viscosity of 100 cP at 25° C., a vinyl group content of 0.4 mole, a cyclic siloxane content of 350 ppm)

Organopolysiloxane-4 (a polysiloxane having a vinyl group at both ends, a viscosity of 2,000 cP at 25° C., a vinyl group content of 0.088 mole, a cyclic siloxane content of 650 ppm)

Organopolysiloxane-5 (a polysiloxane having a vinyl group at both ends, a viscosity of 2,000 cP at 25° C., a vinyl group content of 0.088 mole, a cyclic siloxane content of 750 ppm)

Organopolysiloxane-6 (a polysiloxane having a vinyl group at both ends, a viscosity of 2,000 cP at 25° C., a vinyl group content of 0.088 mole, a cyclic siloxane content of 850 ppm)

Organopolysiloxane-7 (a polysiloxane having a vinyl group at both ends, a viscosity of 2,000 cP at 25° C., a vinyl group content of 0.088 mole, a cyclic siloxane content of 1,100 ppm)

<Second Organopolysiloxane>

Organopolysiloxane-8 (a polysiloxane having a vinyl group at one end, a viscosity of 1,000 cP at 25° C., a vinyl group content of 0.065 mole, a cyclic siloxane content of 380 ppm)

Organopolysiloxane-9 (a polysiloxane having a vinyl group at one end, a viscosity of 1,000 cP at 25° C., a vinyl group content of 0.065 mole, a cyclic siloxane content of 650 ppm)

Organopolysiloxane-10 (a polysiloxane having a vinyl group at one end, a viscosity of 1,000 cP at 25° C., a vinyl group content of 0.065 mole, a cyclic siloxane content of 750 ppm)

Organopolysiloxane-11 (a polysiloxane having a vinyl group at one end, a viscosity of 1,000 cP at 25° C., a vinyl group content of 0.065 mole, a cyclic siloxane content of 850 ppm)

Organopolysiloxane-12 (a polysiloxane having a vinyl group at one end, a viscosity of 1,000 cP of at 25° C., a vinyl group content of 0.065 mole, a cyclic siloxane content of 1,100 ppm)

<First Organo-Hydrogen Polysiloxane>

Organo-hydrogen polysiloxane-1 (a polysiloxane having hydrogen atoms at side chains, a viscosity of 210 cP at 25° C., a cyclic siloxane content of 200 ppm)

Organo-hydrogen polysiloxane-2 (a polysiloxane having hydrogen atoms at side chains, a viscosity of 210 cP at 25° C., a cyclic siloxane content of 650 ppm)

Organo-hydrogen polysiloxane-3 (a polysiloxane having hydrogen atoms at side chains, a viscosity of 210 cP at 25° C., a cyclic siloxane content of 750 ppm)

Organo-hydrogen polysiloxane-4 (a polysiloxane having hydrogen atoms at side chains, a viscosity of 210 cP at 25° C., a cyclic siloxane content of 850 ppm)

Organo-hydrogen polysiloxane-5 (a polysiloxane having hydrogen atoms at side chains, a viscosity of 210 cP at 25° C., a cyclic siloxane content of 1,100 ppm)

<Second Organo-Hydrogen Polysiloxane>

Organo-hydrogen polysiloxane-6 (a polysiloxane having hydrogen atoms at both ends. a viscosity of 150 cP at 25° C., a cyclic siloxane content of 200 ppm)

Organo-hydrogen polysiloxane-7 (a polysiloxane having hydrogen atoms at both ends. a viscosity of 920 cP at 25° C., a cyclic siloxane content of 320 ppm)

Organo-hydrogen polysiloxane-8 (a polysiloxane having hydrogen atoms at both ends, a viscosity of 920 cP at 25° C., a cyclic siloxane content of 650 ppm)

Organo-hydrogen polysiloxane-9 (a polysiloxane having hydrogen atoms at both ends, a viscosity of 920 cP at 25° C., a cyclic siloxane content of 750 ppm)

Organo-hydrogen polysiloxane-10 (a polysiloxane having hydrogen atoms at both ends, a viscosity of 920 cP at 25° C., a cyclic siloxane content of 850 ppm)

Organo-hydrogen polysiloxane-11 (a polysiloxane having hydrogen atoms at both ends, a viscosity of 920 cP at 25° C., a cyclic siloxane content of 1,100 ppm)

<Filler>

Al₂O₃, Daw-45, average particle diameter 45 μm (Denka)

Al₂O₃, Daw-03, average particle diameter 3 μm (Denka)

Al₂O₃, AL-43-M, average particle diameter 1.5 μm (Denka)

<Retarder>

Methylvinylcyclics ([MeViSiO]₄) (95%)

<Curing Catalyst>

1,3-Divinyl-1,1,3,3-tetramethyl-disiloxane-platinum(0)-composite, Pt-VTSC 1.0PS
In the present specification, Vi represents a vinyl group, and Me represents a methyl group.
In the tables below, H/Vi represents a mole ratio of a silicone-binding hydrogen atom in the organo-hydrogen polysiloxane per 1 mole of a silicone-binding vinyl group in the organopolysiloxane.
In the tables below, the total (phr=parts per hundred resins) represents the total (parts by weight) of the other components with respect to 100 parts by weight of the organopolysiloxane (a first organopolysiloxane and a second organopolysiloxane)

TABLE 1

| | Component | Example 1 | Example 2 | Example 3 | Example 4 | Example 5 |
|---|---|---|---|---|---|---|
| First | Organopolysiloxane-1 | 43.6 | | 29.6 | 33.5 | 32.1 |
| Organopolysiloxane | Organopolysiloxane-2 | | 15.2 | 11.8 | | 4.3 |
| | Organopolysiloxane-3 | | 37.9 | 9.9 | 11.2 | 10.7 |
| | Organopolysiloxane-4 | | | | | |
| | Organopolysiloxane-5 | | | | | |
| | Organopolysiloxane-6 | | | | | |
| | Organopolysiloxane-7 | | | | | |
| Second | Organopolysiloxane-8 | 56.4 | 46.9 | 48.7 | 55.3 | 52.9 |
| Organopolysiloxane | Organopolysiloxane-9 | | | | | |
| | Organopolysiloxane-10 | | | | | |
| | Organopolysiloxane-11 | | | | | |
| | Organopolysiloxane-12 | | | | | |
| Total (parts by weight) | | 100.0 | 100.0 | 100.0 | 100.0 | 100.0 |
| First organo- | Organo-hydrogen | 1.7 | 1.9 | 1.4 | 1.6 | 1.6 |
| hydrogen | polysiloxane-1 | | | | | |
| polysiloxane | Organo hydrogen | | | | | |
| | polysiloxane-2 | | | | | |
| | Organo-hydrogen | | | | | |
| | polysiloxane-3 | | | | | |
| | Organo-hydrogen | | | | | |
| | polysiloxane-4 | | | | | |
| | Organo-hydrogen | | | | | |
| | polysiloxane-5 | | | | | |
| Second organo- | Organo-hydrogen | | | 4.6 | | 5.0 |
| hydrogen | polysiloxane-6 | | | | | |
| polysiloxane | Organo-hydrogen | 6.5 | 7.0 | | 7.5 | |
| | polysiloxane-7 | | | | | |
| | Organo-hydrogen | | | | | |
| | polysiloxane-8 | | | | | |
| | Organo-hydrogen | | | | | |
| | polysiloxane-9 | | | | | |
| | Organo-hydrogen | | | | | |
| | polysiloxane-10 | | | | | |
| | Organo-hydrogen | | | | | |
| | polysiloxane-11 | | | | | |
| H/Vi | | 0.6 | 0.3 | 0.6 | 0.4 | 0.6 |
| Filler | Al₂O₃, Daw-45 | 799.0 | 695.8 | 723.2 | 820.2 | 785.1 |
| | Al₂O₃, Daw-03 | 508.0 | 316.0 | 328.7 | 372.8 | 499.6 |
| | Al₂O₃, AL-43-M | | 126.5 | 131.5 | 149.1 | |
| Filler surface | Me₃SiO(Me₂SiO)₃₀SiMe(OMe)₂ | 7.3 | 6.3 | 6.6 | 7.5 | 7.1 |
| treating agent | | | | | | |
| Additives | Fe₃O₄, KN-320 | 0.6 | 0.5 | 0.5 | 0.6 | 0.6 |
| Retarder | [MeViSiO]₄ | 0.2 | 0.2 | 0.2 | 0.2 | 0.2 |
| Catalyst | Pt-VTSC 1.0PS | 1.5 | 1.3 | 1.5 | 1.5 | 1.4 |

| | | | | | |
|---|---|---|---|---|---|
| Total (phr) | 1324.8 | 1155.5 | 1198.2 | 1361 | 1300.6 |

TABLE 2

| | Component | Example 6 | Example 7 | Example 8 |
|---|---|---|---|---|
| First Organopolysiloxane | Organopolysiloxane-1 | | 43.6 | |
| | Organopolysiloxane-2 | | | |
| | Organopolysiloxane-3 | | | |
| | Organopolysiloxane-4 | 43.6 | | 43.6 |
| | Organopolysiloxane-5 | | | |
| | Organopolysiloxane-6 | | | |
| | Organopolysiloxane-7 | | | |
| Second | Organopolysiloxane-8 | 56.4 | | |
| Organopolysiloxane | Organopolysiloxane-9 | | 56.4 | 56.4 |
| | Organopolysiloxane-10 | | | |
| | Organopolysiloxane-11 | | | |
| | Organopolysiloxane-12 | | | |
| Total (parts by weight) | | 100.0 | 100.0 | 100.0 |
| First organo-hydrogen | Organo-hydrogen polysiloxane-1 | | | |
| polysiloxane | Organo-hydrogen polysiloxane-2 | 1.7 | 1.7 | 1.7 |
| | Organo-hydrogen polysiloxane-3 | | | |
| | Organo-hydrogen polysiloxane-4 | | | |
| | Organo-hydrogen polysiloxane-5 | | | |
| Second organo-hydrogen | Organo-hydrogen polysiloxane-6 | | | |
| polysiloxane | Organo-hydrogen polysiloxane-7 | 6.5 | | |
| | Organo-hydrogen polysiloxane-8 | | 6.5 | 6.5 |
| | Organo-hydrogen polysiloxane-9 | | | |
| | Organo-hydrogen polysiloxane-10 | | | |
| | Organo-hydrogen polysiloxane-11 | | | |
| H/Vi | | 0.6 | 0.6 | 0.6 |
| Filler | Al₂O₃, Daw-45 | 799.0 | 799.0 | 799.0 |
| | Al₂O₃, Daw-03 | 508.0 | 508.0 | 508.0 |
| | Al₂O₃, AL-43-M | | | |
| Filler surface treating | Me₃SiO(Me₂SiO)₃₀SiMe(OMe)₂ | 7.3 | 7.3 | 7.3 |
| agent | | | | |
| Additives | Fe₃O₄, KN-320 | 0.6 | 0.6 | 0.6 |
| Retarder | [MeViSiO]₄ | 0.2 | 0.2 | 0.2 |
| Catalyst | Pt-VTSC 1.0PS | 1.5 | 1.5 | 1.5 |

| | | | |
|---|---|---|---|
| Total (phr) | 1324.8 | 1324.8 | 1324.8 |

TABLE 3

| | Component | Example9 | Example10 | Example11 |
|---|---|---|---|---|
| First Organopolysiloxane | Organopolysiloxane-1 | | 43.6 | |
| | Organopolysiloxane-2 | | | |
| | Organopolysiloxane-3 | | | |
| | Organopolysiloxane-4 | | | |
| | Organopolysiloxane-5 | 43.6 | | 43.6 |
| | Organopolysiloxane-6 | | | |
| | Organopolysiloxane-7 | | | |
| Second | Organopolysiloxane-8 | 56.4 | | |
| Organopolysiloxane | Organopolysiloxane-9 | | | |
| | Organopolysiloxane-10 | | 56.4 | 56.4 |
| | Organopolysiloxane-11 | | | |
| | Organopolysiloxane-12 | | | |
| Total (parts by weight) | | 100.0 | 100.0 | 100.0 |
| First organo-hydrogen | Organo-hydrogenpolysiloxane-1 | | | |
| polysiloxane | Organo-hydrogenpolysiloxane-2 | | | |
| | Organo-hydrogenpolysiloxane-3 | 1.7 | 1.7 | 1.7 |
| | Organo-hydrogenpolysiloxane-4 | | | |
| | Organo-hydrogenpolysiloxane-5 | | | |
| Second organo-hydrogen | Organo-hydrogenpolysiloxane-6 | | | |
| polysiloxane | Organo-hydrogenpolysiloxane-7 | 6.5 | | |
| | Organo-hydrogenpolysiloxane-8 | | | |
| | Organo-hydrogenpolysiloxane-9 | | 6.5 | 6.5 |
| | Organo-hydrogenpolysiloxane-10 | | | |
| | Organo-hydrogenpolysiloxane-11 | | | |
| H/Vi | | 0.6 | 0.6 | 0.6 |
| Filler | Al₂O₃, Daw-45 | 799.0 | 799.0 | 799.0 |
| | Al₂O₃, Daw-03 | 508.0 | 508.0 | 508.0 |
| | Al₂O₃, AL-43-M | | | |
| Filler surface treating | Me₃SiO(Me₂SiO)₃₀SiMe(OMe)₂ | 7.3 | 7.3 | 7.3 |
| agent | | | | |
| Additives | Fe₃O₄, KN-320 | 0.6 | 0.6 | 0.6 |
| Retarder | [MeViSiO]₄ | 0.2 | 0.2 | 0.2 |
| Catalyst | Pt-VTSC 1.0PS | 1.5 | 1.5 | 1.5 |

| | | | |
|---|---|---|---|
| Total (phr) | 1324.8 | 1324.8 | 1324.8 |

TABLE 4

| | Component | Example 12 | Example 13 | Example 14 |
|---|---|---|---|---|
| First | Organopolysiloxane-1 | | 43.6 | |
| Organopolysiloxane | Organopolysiloxane-2 | | | |
| | Organopolysiloxane-3 | | | |
| | Organopolysiloxane-4 | | | |
| | Organopolysiloxane-5 | | | |
| | Organopolysiloxane-6 | 43.6 | | 43.6 |
| | Organopolysiloxane-7 | | | |
| Second | Organopolysiloxane-8 | 56.4 | | |
| Organopolysiloxane | Organopolysiloxane-9 | | | |
| | Organopolysiloxane-10 | | | |
| | Organopolysiloxane-11 | | 56.4 | 56.4 |
| | Organopolysiloxane-12 | | | |
| Total (parts by weight) | | 100.0 | 100.0 | 100.0 |
| First organo-hydrogen | Organo-hydrogen polysiloxane-1 | | | |
| polysiloxane | Organo-hydrogen polysiloxane-2 | | | |
| | Organo-hydrogen polysiloxane-3 | | | |
| | Organo-hydrogen polysiloxane-4 | 1.7 | 1.7 | 1.7 |
| | Organo-hydrogen polysiloxane-5 | | | |
| Second organo-hydrogen | Organo-hydrogen polysiloxane-6 | | | |
| polysiloxane | Organo-hydrogen polysiloxane-7 | 6.5 | | |
| | Organo-hydrogen polysiloxane-8 | | | |
| | Organo-hydrogen polysiloxane-9 | | | |
| | Organo-hydrogen polysiloxane-10 | | 6.5 | 6.5 |
| | Organo-hydrogen polysiloxane-11 | | | |
| H/Vi | | 0.6 | 0.6 | 0.6 |
| Filler | Al₂O₃, Daw-45 | 799.0 | 799.0 | 799.0 |
| | Al₂O₃, Daw-03 | 508.0 | 508.0 | 508.0 |
| | Al₂O₃, AL-43-M | | | |
| Filler surface treating | Me₃SiO(Me₂SiO)₃₀SiMe(OMe)₂ | 7.3 | 7.3 | 7.3 |
| agent | | | | |
| Additives | Fe₃O₄, KN-320 | 0.6 | 0.6 | 0.6 |
| Retarder | [MeViSiO]₄ | 0.2 | 0.2 | 0.2 |
| Catalyst | Pt-VTSC 1.0PS | 1.5 | 1.5 | 1.5 |

| | | | |
|---|---|---|---|
| Total (phr) | 1324.8 | 1324.8 | 1324.8 |

TABLE 5

| | | Comparative | Comparative | Comparative | Comparative | Comparative | Comparative |
|---|---|---|---|---|---|---|---|
| | Component | Example 1 | Example 2 | Example 3 | Example 4 | Example 5 | Example 6 |
| First | Organopolysiloxane-1 | | | 43.6 | | | 100.0 |
| Organopoly- | Organopolysiloxane-2 | 15.2 | | | | | |
| siloxane | Organopolysiloxane-3 | 37.9 | | | | | |
| | Organopolysiloxane-4 | | | | | | |
| | Organopolysiloxane-5 | | | | | | |
| | Organopolysiloxane-6 | | | | | | |
| | Organopolysiloxane-7 | | 43.6 | | 43.6 | 43.6 | |
| Second | Organopolysiloxane-8 | 46.9 | 56.4 | | | | |
| Organopoly- | Organopolysiloxane-9 | | | | | | |
| siloxane | Organopolysiloxane-10 | | | | | | |
| | Organopolysiloxane-11 | | | | | | |
| | Organopolysiloxane-12 | | | 56.4 | 56.4 | 56.4 | |
| Total (parts by weight) | | 100.0 | 100.0 | 100.0 | 100.0 | 100.0 | 100.0 |
| First organo- | Organo-hydrogen | | | | | | 6.5 |
| hydrogen | polysiloxane-1 | | | | | | |
| polysiloxane | Organo-hydrogen | | 1.7 | 1.7 | 1.7 | | |
| | polysiloxane-2 | | | | | | |
| | Organo-hydrogen | | | | | | |
| | polysiloxane-3 | | | | | | |
| | Organo-hydrogen | | | | | | |
| | polysiloxane-4 | | | | | | |
| | Organo-hydrogen | 1.9 | | | | 1.7 | |
| | polysiloxane-5 | | | | | | |
| Second organo- | Organo-hydrogen | | | | | | |
| hydrogen | polysiloxane-6 | | | | | | |
| polysiloxane | Organo-hydrogen | | 6.5 | | | | 1.5 |
| | polysiloxane-7 | | | | | | |
| | Organo-hydrogen | | | | | | |
| | polysiloxane-8 | | | | | | |
| | Organo-hydrogen | | | | | | |
| | polysiloxane-9 | | | | | | |
| | Organo-hydrogen | | | | | | |
| | polysiloxane-10 | | | | | | |
| | Organo-hydrogen | 7.0 | | 6.5 | 6.5 | 6.5 | |
| | polysiloxane-11 | | | | | | |
| H/Vi | | 0.3 | 0.6 | 0.6 | 0.6 | 0.6 | 1.7 |
| Filler | Al₂O₃, Daw-45 | 695.8 | 799.0 | 799.0 | 799.0 | 799.0 | 798.7 |
| | Al₂O₃, Daw-03 | 316.0 | 508.0 | 508.0 | 508.0 | 508.0 | 508.3 |
| | Al₂O₃, AL-43-M | 126.5 | | | | | |
| Filler surface | Me₃SiO(Me₂SiO)₃₀SiMe(OMe)₂ | 6.3 | 7.3 | 7.3 | 7.3 | 7.3 | 7.3 |
| treating agent | | | | | | | |
| Additives | Fe₃O₄, KN-320 | 0.5 | 0.6 | 0.6 | 0.6 | 0.6 | 0.6 |
| Retarder | [MeViSiO]₄ | 0.2 | 0.2 | 0.2 | 0.2 | 0.2 | 0.2 |
| Catalyst | Pt-VTSC 1.0PS | 1.3 | 1.5 | 1.5 | 1.5 | 1.5 | 1.5 |

| | | | | | | |
|---|---|---|---|---|---|---|
| Total (phr) | 1155.5 | 1324.8 | 1324.8 | 1324.8 | 1324.8 | 1324.6 |

### Test Example

The specific gravity, viscosity, hardness, thermal conductivity, volume resistance, hardness heat resistance for the cured silicone heat-dissipating gel were measured by the following method.

[Test Method]

1) Specific Gravity

Specific gravity was measured at 25° C. according to ASTM D 792.

2) Viscosity

Viscosity was measured at 25° C. according to ASTM D 4287.

3) Hardness

Initial hardness was measured according to JIS K7321.

5) Thermal Conductivity

Thermal conductivity of a composition was measured according to JIS R2616.

6) Volume Resistance

Compositions obtained from examples and comparative examples were applied on CPU which is actually applied, and volume resistance was measured at 25° C. according to ASTM D257.

7) Hardness Heat Resistance

The evaluation sample was in the hot-air circulation dryer at 160° C. after 3000 hours, and heat resistance was evaluated by measuring hardness according to JIS K 7321.

The results of the test examples are shown in tables 6-8 below.

TABLE 6

| Item | Unit | Example 1 | Example 2 | Example 3 | Example 4 | Example 5 | Example 6 | Example 7 | Example 8 |
|---|---|---|---|---|---|---|---|---|---|
| Specific | — | 3.03 | 3.00 | 3.00 | 3.07 | 3.02 | 3.01 | 3.02 | 3.05 |
| gravity | | | | | | | | | |
| Viscosity | cP | 220,000 | 90,000 | 110,000 | 180,000 | 170,000 | 220,000 | 205,000 | 205,000 |
| Hardness | Asker C | 19 | 20 | 18 | 22 | 19 | 19 | 18 | 18 |
| Thermal | W/m · K | 3.2 | 3.1 | 3.1 | 3.5 | 3.2 | 3.2 | 3.2 | 3.1 |
| conductivity | | | | | | | | | |
| Volume | Ωm | 10\hat{ }11 | 10\hat{ }11 | 10\hat{ }11 | 10\hat{ }11 | 10\hat{ }11 | 10\hat{ }11 | 10\hat{ }11 | 10\hat{ }11 |
| resistance | | | | | | | | | |
| Hardness | Asker C | 23 | 25 | 25 | 24 | 25 | 30 | 29 | 30 |
| heat | | | | | | | | | |
| resistance | | | | | | | | | |
| (160° C., | | | | | | | | | |
| after | | | | | | | | | |
| 3000 hrs, | | | | | | | | | |
| hardness | | | | | | | | | |
| value | | | | | | | | | |
| measured) | | | | | | | | | |
| Hardness | + | 4 | 5 | 7 | 2 | 6 | 11 | 11 | 12 |
| rise | | | | | | | | | |
| Low | ppm | 50 | 55 | 60 | 35 | 55 | 85 | 90 | 95 |
| molecular | | | | | | | | | |
| siloxane | | | | | | | | | |

TABLE 7

| | | | Example | Example | Example | Example | Example |
|---|---|---|---|---|---|---|---|
| Item | Unit | Example 9 | 10 | 11 | 12 | 13 | 14 |
| Specific | — | 3.02 | 3.00 | 3.03 | 3.01 | 3.02 | 3.03 |
| gravity | | | | | | | |
| Viscosity | cP | 210,000 | 205,000 | 200,000 | 205,000 | 210,000 | 205,000 |
| Hardness | Asker C | 18 | 18 | 19 | 18 | 19 | 21 |
| Thermal | W/m · K | 3.2 | 3.2 | 3.1 | 3.1 | 3.2 | 3.2 |
| conductivity | | | | | | | |
| Volume | Ωm | 10\hat{ }11 | 10\hat{ }11 | 10\hat{ }11 | 10\hat{ }11 | 10\hat{ }11 | 10\hat{ }11 |
| resistance | | | | | | | |
| Hardness heat | Asker C | 32 | 33 | 33 | 38 | 38 | 39 |
| resistance | | | | | | | |
| (160° C., after | | | | | | | |
| 3000 hrs, | | | | | | | |
| hardness value | | | | | | | |
| measured) | | | | | | | |
| Hardness rise | + | 14 | 15 | 14 | 20 | 19 | 18 |
| Low molecular | ppm | 115 | 120 | 130 | 185 | 180 | 195 |
| siloxane | | | | | | | |

TABLE 8

| | | Comparative | Comparative | Comparative | Comparative | Comparative | Comparative |
|---|---|---|---|---|---|---|---|
| | | Example | Example | Example | Example | Example | Example |
| Item | Unit | 1 | 2 | 3 | 4 | 5 | 6 |
| Specific | — | 3.00 | 3.05 | 3.05 | 3.06 | 3.07 | 3.03 |
| gravity | | | | | | | |
| Viscosity | cP | 70,000 | 205,000 | 200,000 | 205,000 | 210,000 | 335,000 |
| Hardness | Asker C | 17 | 19 | 19 | 21 | 19 | 19 |
| Thermal | W/m · K | 3.1 | 3.2 | 3.2 | 3.2 | 3.2 | 3.2 |
| conductivity | | | | | | | |
| Volume | Ωm | 10\hat{ }11 | 10\hat{ }11 | 10\hat{ }11 | 10\hat{ }11 | 10\hat{ }11 | 10\hat{ }11 |
| resistance | | | | | | | |
| Hardness heat | Asker C | 46 | 45 | 45 | 47 | 50 | 35 |
| resistance | | | | | | | |
| (160° C., after | | | | | | | |
| 3000 hrs, | | | | | | | |
| hardness value | | | | | | | |
| measured) | | | | | | | |
| Hardness rise | + | 29 | 26 | 26 | 26 | 31 | 16 |
| Low molecular | ppm | 250 | 300 | 360 | 420 | 435 | 65 |
| siloxane | | | | | | | |

Since a heat-dissipating gel-type silicone rubber composition according to an embodiment of the present invention, as can be confirmed in tables 6 to 8, has a low hardness rise, it can be confirmed that the hardness heat resistance in the examples is better than that in the comparative examples. In particular, it could be confirmed that the cases of Examples 1 to 5 have a low hardness rise, and thus show the most excellent hardness heat resistance.

1. A heat-dissipating gel-type silicone rubber composition comprising an organopolysiloxane,
wherein the heat-dissipating gel-type silicone rubber composition further comprises, with respect to 100 parts by weight of the organopolysiloxane:
0.1-25 parts by weight of an organo-hydrogen polysiloxane;
1,100-2,000 parts by weight of a filler;
5-50 parts by weight of a filler surface treating agent; and
0.1-5 parts by weight of a catalyst;
wherein the organopolysiloxane and the organo-hydrogen polysiloxane each comprise 1,000 ppm or less of a cyclic siloxane therein.

2. The heat-dissipating gel-type silicone rubber composition of claim 1, wherein the cyclic siloxane has 3-10 siloxane units.

3. The heat-dissipating gel-type silicone rubber composition of claim 1, wherein the mixture weight ratio of the organopolysiloxane and the organo-hydrogen polysiloxane is 1:0.01 to 0.2.

4. The heat-dissipating gel-type silicone rubber composition of claim 1,
wherein the mole ratio (H/Vi) of a silicone-binding hydrogen atom in the organo-hydrogen polysiloxane per 1 mole of a silicone-binding vinyl group in the organopolysiloxane is 0.2 to 1.0.

5. The heat-dissipating gel-type silicone rubber composition of claim 1, wherein the organopolysiloxane comprises two or more kinds of organopolysiloxanes, including a mixture of a first organopolysiloxane having the vinyl group at both ends or at both ends and side chains and a second organopolysiloxane having the vinyl group at one end or at one end and side chains.

6. The heat-dissipating gel-type silicone rubber composition of claim 1, wherein the organopolysiloxane comprises a mixture of a first organo-hydrogen polysiloxane having hydrogen atoms at side chains and a second organo-hydrogen polysiloxane having hydrogen atoms at both ends.
